(19) United States
(12) Patent Application Publication
(10) Pub. No.: US 2012/0048755 A1
(43) Pub. Date: Mar. 1, 2012

(54) Efficiently compartmentalized box for multiple functions

(76) Inventor: Chung Piao Tsao, Taipei (TW)

(21) Appl. No.: 12/807,104

(22) Filed: Aug. 30, 2010

(51) Int. Cl. B65D 85/00; G04B 47/00; H02J 7/00; B65D 25/04; H01M 10/46

(52) U.S. Cl. 206/320; 220/553; 206/459.5; 320/101; 320/107; 368/10

(57) ABSTRACT

A box includes a casing, a front compartment recessed in a front portion of the casing for storing a portable electronic device including cellular phone in the front compartment; an upper compartment formed in an upper portion of the casing for storing namecards or notepapers therein; and a bottom compartment formed in a lower portion of the casing and positioned under the upper compartment for mounting a charger in the bottom compartment for supplying electricity for powering a plurality of electronic devices.

### BACKGROUND OF THE INVENTION

U.S. Pat. No. 5,069,333 disclosed a namecard holder for storing namecards into the holder or for dispensing namecards from the holder.

U.S. Pat. No. 6,955,280 disclosed a cellular phone securing device which is mounted on a carrying holder to be fixed on an article or in an interior of a vehicle.

However, none of the prior arts discloses a device or a container for simultaneously holding the namecards and a cellular phone in the device or container for a convenient use of the cards or phone.

The present inventor has found the drawbacks of the prior arts and invented the present box for multiple functions.

### SUMMARY OF THE INVENTION

The object of the present invention is to provide a box including a casing, a front compartment recessed in a front portion of the casing for storing a portable electronic device including cellular phone in the front compartment; an upper compartment formed in an upper portion of the casing for storing namecards or notepapers therein; and a bottom compartment formed in a lower portion of the casing and positioned under the upper compartment for mounting a charger in the bottom compartment for supplying electricity for powering a plurality of electronic devices.

### BRIEF DESCRIPTION OF THE DRAWINGS

FIG. 1 is an illustration showing the present invention for holding a cellular phone and notepapers in a casing.

FIG. 2 is a perspective view of the present invention when removing the phone from FIG. 1.

FIG. 3 is a partial sectional drawing of the present invention.

FIG. 4 shows an electronic device horizontally held on the casing of the present invention.

FIG. 5 is a perspective rear view of the present invention having a power card connected thereto for charging the charger mounted in the casing.

FIG. 6 is an illustration showing the solar cells as provided on a bottom wall of the casing for charging the charger in the casing, which is turned the upside down.

FIG. 7 is an illustration showing the present invention as laid on an interior surface of a car C.

FIG. 8 shows the present invention having a time piece formed on a front wall of the casing.

FIG. 9 shows a display such as for advertising purpose formed on a top wall of the casing.

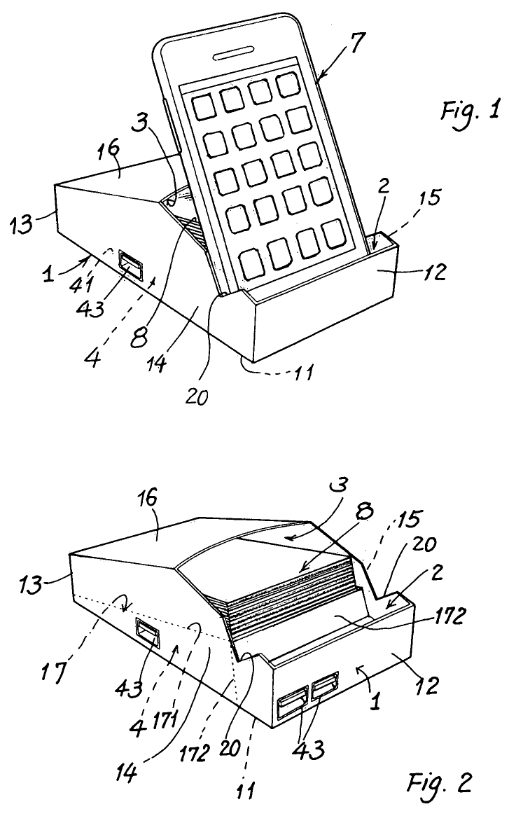

### DETAILED DESCRIPTION

As shown in the drawings, the present invention comprises: a casing 1; a front compartment 2 recessed in a front portion of the casing 1 for holding a portable electronic device 7 in the front compartment 2; an upper compartment 3 formed in an upper portion of the casing 1 for storing namecards or notepapers 8 in the upper compartment 3; and a bottom compartment 4 formed in a lower or bottom portion of the casing 1 and positioned under the upper compartment 3 for mounting a charger 41 in the bottom compartment 4.

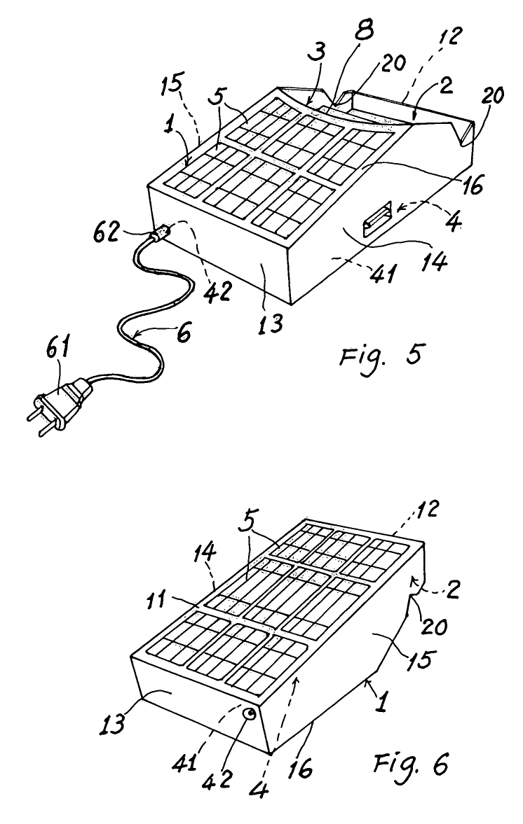

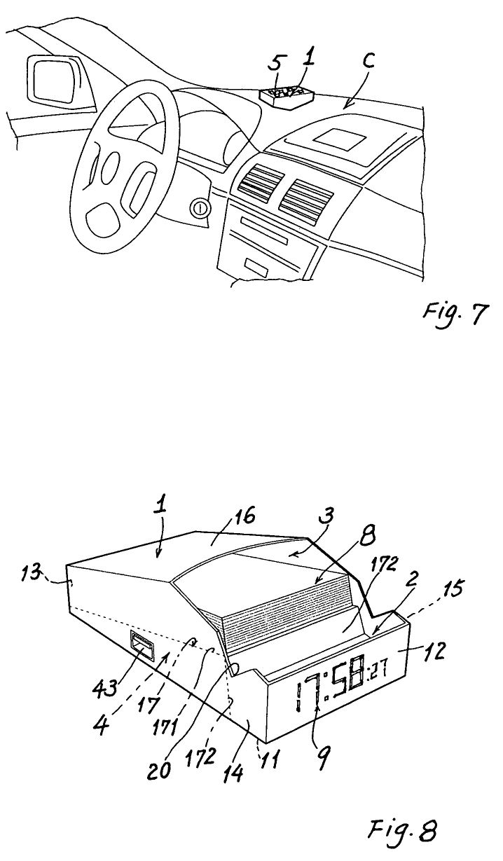

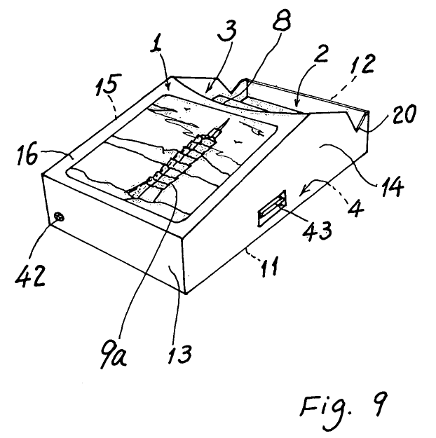

A plurality of solar cells 5 are disposed on the outer surface of the casing 1, especially on the top wall 16 and bottom wall 11 of the casing 1 as shown in FIGS. 5 and 6 for charging the charger 41 by converting solar energy into electricity which is charged into a charging circuit including at least a rechargeable battery as secured in the bottom compartment 4 for storing electricity in the charging circuit and rechargeable battery of the charger 41.

As shown in FIG. 5, a power cord 6 having a plug (or cigarette-lighter plug) 61 which is plugged in a receptacle of an utility power source and or a DC power source in a car for leading the electricity from the utility power source or DC power source in a car, through a cord terminal 62 of the power cord 6 and through a power terminal (or a socket or jack) 42 formed in the casing 1 to charge the charging circuit (including a rechargeable battery of the charging circuit) of the charger 41 as secured in the bottom compartment 4 of the casing 1.

So, the charger 41 of the present invention may be charged either by solar cells which absorb solar energy and convert into electricity, or a DC power source, or AC power source such as supplied from a municipal utility power supply system.

The charger 41 may further include a data store (or memory) to receive, store, or send data from or to an electronic device including a computer through at least an interface terminal or port 43 formed on the casing 1 of the present inventions.

The portable electronic device 7 as held in or laid on the front compartment 2 may include: a cellular phone, iPhone, iPad, iPod, GPS, game, PSP, portable media players (including MP3, MP4) or any other miniature portable electronic devices.

Such a portable electronic device 7, besides its power supply directly provided in the electronic device itself, may also be powered by the charger 41 of the present invention by linking a power cord (not shown), which has an input connector connected to the interface terminal 43 formed on the casing 1 and an output connector (including USB connector) connectable to the electronic device 7.

The interface terminal 43 of the charger 41 may include an interface port, a female connector, a male connector, a jack, or any other terminals for electrically or electronically connecting the charger 41 of the present invention to the other portable electronic devices.

An USB connector, USB port, USB hub or USB system or device may also be connected to the charger 41 of the present invention for linking other electronic devices or computers including laptop or notebook PC, etc.

The terminal 43 may also be electrically connected to a LED lamp or any other electric or electronic devices. The terminals 42, 43 may be formed in the rear wall 13 or the side walls 14, 15.

The casing 1 may be made from plural materials including: paper, leather, cloth, wooden material, ceramic, glass, crystal, plastic or any other suitable materials, not limited in the present invention.

A time piece or digital clock 9 may be formed on the casing 1, such as formed on the front wall 12 of the casing 1 as shown in FIG. 8.

A display 9a including advertising design, figures, patterns, description, logo or trademark, a LCD display, or any other display means may be formed on the surface such as on the top wall 16 of the casing 1 as shown in FIG. 9. If the display 9a is a LCD, it may be electrically connected to the charger 41 for powering the display 9a either for audio or visual display. Such a display 9a may co-exist with the solar cells 5 on the top wall 16, or the solar cells 5 may be eliminated to increase the display area for advertisement or the like.

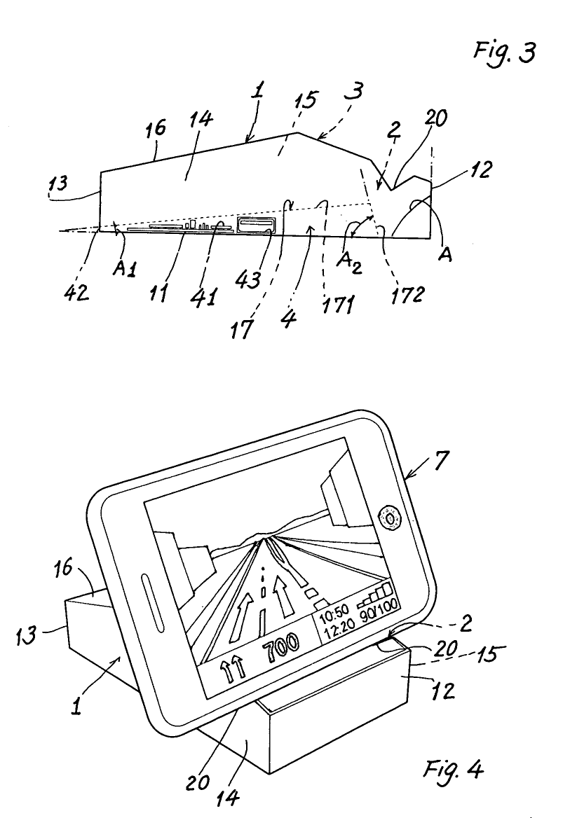

The casing 1 of the present invention includes: a bottom wall (or plate) 11, a front wall 12 which is vertically erected from a front end of the bottom wall 11, or upwardly erected to be slightly rearwardly inclined to define an acute angle A of about 85 degrees to 75 degrees (but not limited in this invention) between the front wall and the bottom wall as shown in FIG. 3, a rear wall 13 formed on a rear portion of the casing 1 and vertically erected from the bottom wall 11, a left side wall 14 and a right side wall 15 respectively disposed on left and right sides of the casing 1 as vertically erected from the bottom wall 11, a top wall 16 formed on a top portion of the casing 1, and a L-shaped partition wall 17 formed in a middle portion of the casing 1.

The L-shaped partition wall 17 includes a diaphragm plate 171 slightly inclined and tapered rearwardly and downwardly to define an acute angle A1 (of about 10˜15 degrees, but not limited) between the bottom wall 11 and the diaphragm plate 171; and a back plate 172 erected upwardly from the bottom wall 11 and slightly inclined rearwardly to define an acute angle A2 of about 60˜75 degrees (but not limited) between the bottom wall 11 and the back plate 172 (FIG. 3).

The charger 41, including a charging circuit and at least a rechargeable battery, is secured in the bottom compartment 4 as confined among the bottom wall 11, the L-shaped partition wall 17, the left and right side walls 14, 15, and the rear wall 13, especially as shown in FIGS. 2 and 3.

The front compartment 2 may be formed with a pair of notches 20 on the left and right side walls 14, 15 for laying the portable electronic device 7 such as cell phone or a GPS device on the notches 20 of the front compartment.

A charging connector or terminal (not shown) may be provided in a bottom portion of the front compartment 2 for charging the portable electronic device 7 (such as a cell phone) when held in the front compartment 2. Such a charging connector in the front compartment 2 will be electrically connected to the charger 41 as secured in the bottom compartment 4.

The front compartment 2 is confined among the front wall 12, the back plate 172 of the partition wall 17, the bottom wall 11, and the left and right side walls 14, 15 (FIG. 2).

The upper compartment 3 is confined among the top wall 16, the diaphragm plate 171 of the partition wall 17, the rear wall 13, the left and right side walls 14, 15 (FIG. 2).

The present invention may be further modified without departing from the scope and the spirit of the present invention. The present invention provides a compact box to accommodate plural items in the related compartments in the casing to efficiently use the space or volume of the box.

Even the front compartment 2 and the upper compartment 3 have a common opening as shown in the figures, however they may be respectively separately provided with two individual openings or slots, so that each said compartment 2 or 3 has its own opening.

At least a speaker or a paper speaker may be formed on said casing, such as on any side wall 14 or 15 of the casing 1 of the present invention.

I claim:

1. A box comprising:
a casing;
a front compartment recessed in a front portion of the casing for holding a portable electronic device in or on the front compartment;
an upper compartment formed in an upper portion of the casing for storing namecards or notepapers in the upper compartment; and
a bottom compartment formed in a lower or bottom portion of the casing and positioned under the upper compartment for mounting a charger in the bottom compartment.

2. A box according to claim 1, wherein said casing further includes a plurality of solar cells disposed on an outer surface of the casing for charging the charger by converting solar energy into electricity which is charged into a charging circuit including at least a rechargeable battery as secured in the bottom compartment for storing electricity in the charger.

3. A box according to claim 1, wherein said box further includes a power cord having a plug which is plugged in a receptacle of an utility power source and or a DC power source in a car for leading the electricity from the utility power source or DC power source in a car, through a cord terminal of the power cord and through a power terminal formed in the casing to charge a charging circuit of the charger as secured in the bottom compartment of the casing.

4. A box according to claim 1, wherein said charger further includes a data store to receive, store, or send data from or to an electronic device including a computer through at least an interface terminal or port formed on the casing.

5. A box according to claim 1, wherein said portable electronic device as held in or laid on the front compartment includes: a cellular phone, iPhone, iPad, iPod, GPS, a game, PSP, a portable media player and a miniature portable electronic device.

6. A box according to claim 1, wherein said charger includes at least one interface terminal, which includes an interface port, a female connector, a male connector, a jack, or a terminal formed on said casing for electrically or electronically connecting the charger to an electronic device.

7. A box according to claim 1, wherein said casing further includes a time piece or digital clock formed on the casing.

8. A box according to claim 1, wherein said casing includes a display, which includes an advertising design, figures, patterns, a description, a logo or trademark, a LCD display, and a display means formed on a surface of the casing.

9. A box according to claim 1, wherein said casing includes: a bottom wall, a front wall which is vertically erected from a front end of the bottom wall or upwardly erected from said bottom wall to be slightly rearwardly inclined to define a first acute angle A of about 85 degrees to 75 degrees between the front wall and the bottom wall, a rear wall formed on a rear portion of the casing and vertically erected from the bottom wall, a left side wall and a right side wall respectively disposed on left and right sides of the casing as vertically erected from the bottom wall, a top wall formed on a top portion of the casing, and a L-shaped partition wall formed in a middle portion of the casing.

10. A box according to claim 9, wherein said L-shaped partition wall includes a diaphragm plate slightly inclined and tapered rearwardly and downwardly to define a second acute angle A1 of about 10˜15 degrees between the bottom wall and the diaphragm plate; and a back plate erected upwardly from the bottom wall and slightly inclined rearwardly to define a third acute angle A2 of about 60˜75 degrees between the bottom wall and the back plate.

11. A box according to claim 9, wherein said casing includes a bottom compartment for mounting a charger, including a charging circuit and at least a rechargeable battery, in the bottom compartment as confined among the bottom wall, the L-shaped partition wall, the left and right side walls, and the rear wall.

12. A box according to claim 1, wherein said front compartment is formed with a pair of notches on a left and a right side wall of said casing for laying the portable electronic device including a cell phone or a GPS device on the notches of the front compartment.

13. A box according to claim 1, wherein said front compartment further includes a charging connector or terminal formed in a bottom portion of the front compartment for charging the portable electronic device when held in the front compartment, said charging connector in the front compartment electrically connected to the charger as secured in the bottom compartment.

14. A box according to claim 9, wherein said casing includes a front compartment which is confined among the front wall, a back plate of the partition wall, the bottom wall, and the left and right side walls.

15. A box according to claim 9, wherein said casing includes an upper compartment which is confined among the top wall, a diaphragm plate of the partition wall, the rear wall, the left and right side walls.

16. A box according to claim 1, wherein said casing includes a speaker or paper speaker formed on a wall of said casing.

17. A box comprising:
a casing;
a front compartment formed in a front portion of said casing for holding a portable electronic device including a cellular phone in said front compartment; and
an upper compartment formed in an upper portion of said casing, adjacent to said front compartment, for storing namecards or notepapers in said upper compartment.
